(19) United States
(12) Patent Application Publication
(10) Pub. No.: US 2015/0264385 A1
(43) Pub. Date: Sep. 17, 2015

(54) FRAME INTERPOLATION DEVICE, FRAME INTERPOLATION METHOD, AND RECORDING MEDIUM

(71) Applicant: Kabushiki Kaisha Toshiba, Tokyo (JP)

(72) Inventor: Takaya Ogawa, Kawasaki Kanagawa (JP)

(21) Appl. No.: 14/461,693

(22) Filed: Aug. 18, 2014

(30) Foreign Application Priority Data
Mar. 14, 2014 (JP) 2014-052208

(51) Int. Cl. H04N 19/513; H04N 19/139

(52) U.S. Cl. CPC H04N 19/513; H04N 19/139

(57) ABSTRACT

According to one embodiment, a frame interpolation device includes a motion vector interpolation unit that assigns interpolated motion vectors calculated based on motion vectors indicating motions of an image between frames and a temporal position of an interpolated frame inserted between the two frames to the interpolated frame per unit region, a motion-compensated image generation unit that generates a forward motion-compensated image and a backward motion-compensated image based on the interpolated motion vectors, and an interpolated frame generation unit that generates the interpolated frame by averaging corresponding regions of the forward motion-compensated image and the backward motion-compensated image by different weights between a normal region in which one or one pair of interpolated motion vectors is assigned per unit region and a non-normal region which is configured of at least one of a collided region and a vacant region.

### CROSS-REFERENCE TO RELATED APPLICATION

This application is based upon and claims the benefit of priority from the prior Japanese Patent Application No. 2014-052208 filed in Japan on Mar. 14, 2014; the entire contents of which are incorporated herein by reference.

### FIELD

Embodiments described herein relate generally to a frame interpolation device, a frame interpolation method and a recording medium.

### BACKGROUND

There is a known technique for inserting interpolated frames between frames thereby to smooth a video. An interpolated frame generation device typically generates an interpolated frame based on motion vectors acquired by searching a video.

An occlusion region occurs in a video shooting a moving object therein in many cases. The “occlusion region” is a region where, since an object overlaps the background or the like behind the object, no background or the like behind the object can temporarily be seen. Image information on the background or the like behind the object is lost in the occlusion region, and thus no correct motion vector can be acquired in many cases. When no correct motion vector can be acquired, an interpolated frame generated by the interpolated frame generation device becomes an unnatural image.

### BRIEF DESCRIPTION OF THE DRAWINGS

FIG. 1 is a block diagram of a frame interpolation device according to an embodiment;

FIG. 2 is a flowchart illustrating a motion estimation processing according to the embodiment;

FIG. 3 is a diagram illustrating how a base frame is divided into a plurality of blocks;

FIG. 4 is a diagram illustrating how a similar part to a block to be searched is searched from a reference frame;

FIG. 5 is a diagram illustrating exemplary input frames (reference frame and base frame);

FIG. 6 is a partially-enlarged diagram of the input frames illustrated in FIG. 5;

FIG. 7 is a diagram illustrating how motion vectors are assigned to a base frame;

FIG. 8 is a functional block diagram illustrating the function of a motion compensation unit provided in the frame interpolation device;

FIG. 9 is a diagram illustrating how three interpolated frames are inserted between two input frames;

FIG. 10 is a diagram illustrating a relationship between a motion vector and interpolated motion vectors;

FIG. 11 is a flowchart illustrating a motion compensation processing according to the embodiment;

FIG. 12 is a flowchart illustrating a motion vector interpolation processing according to the embodiment;

FIG. 13 is a diagram illustrating how an interpolated motion vector is calculated based on a motion vector assigned to a base frame;

FIG. 14 is a diagram illustrating a vacant region and a collided region;

FIG. 15 is a diagram illustrating how interpolated motion vectors are assigned to an interpolated frame;

FIG. 16 is a flowchart illustrating a motion-compensated image generation processing according to the embodiment;

FIG. 17 is a diagram illustrating how a backward motion-compensated image is generated;

FIG. 18 is a diagram illustrating an exemplary backward motion-compensated image;

FIG. 19 is a diagram illustrating how a forward motion-compensated image is generated;

FIG. 20 is a diagram illustrating an exemplary forward motion-compensated image;

FIG. 21 is a flowchart illustrating an interpolated frame generation processing according to the embodiment;

FIG. 22 is a diagram illustrating an exemplary interpolated frame generated when a weight coefficient used for averaging non-normal regions is not shifted;

FIG. 23 is a diagram illustrating exemplary neighboring pixels;

FIG. 24 is a diagram illustrating a relationship between a degree of confidence and a weight coefficient;

FIG. 25 is a diagram illustrating an exemplary interpolated frame generated when a weight coefficient used for averaging non-normal regions is shifted; and

FIG. 26 is a diagram illustrating a relationship between a rate of neighboring pixels and a degree of confidence.

### DETAILED DESCRIPTION

A frame interpolation device according to an embodiment includes a motion vector interpolation unit that, based on motion vectors indicating motions of an image between two frames and a temporal position of an interpolated frame inserted between the two frames, calculates interpolated motion vectors indicating motions of images between the interpolated frame and the two frames, and assigns the calculated interpolated motion vectors to the interpolated frame per unit region, a motion-compensated image generation unit that generates a forward motion-compensated image generated based on image information on the forward frame out of the two frames and the interpolated motion vectors, and a backward motion-compensated image generated based on image information on the backward frame out of the two frames and the interpolated motion vectors, and an interpolated frame generation unit that generates the interpolated frame by averaging corresponding regions of the forward motion-compensated image and the backward motion-compensated image by different weights between a normal region in which one or one pair of interpolated motion vectors is assigned per unit region and a non-normal region which is configured of at least one of a collided region assigned with a plurality or a plurality of pairs of interpolated motion vectors per unit region and a vacant region assigned with no interpolated motion vector.

The present embodiment will be described below with reference to the drawings. In the drawings, the same reference numerals are denoted to the same or like reference numerals.

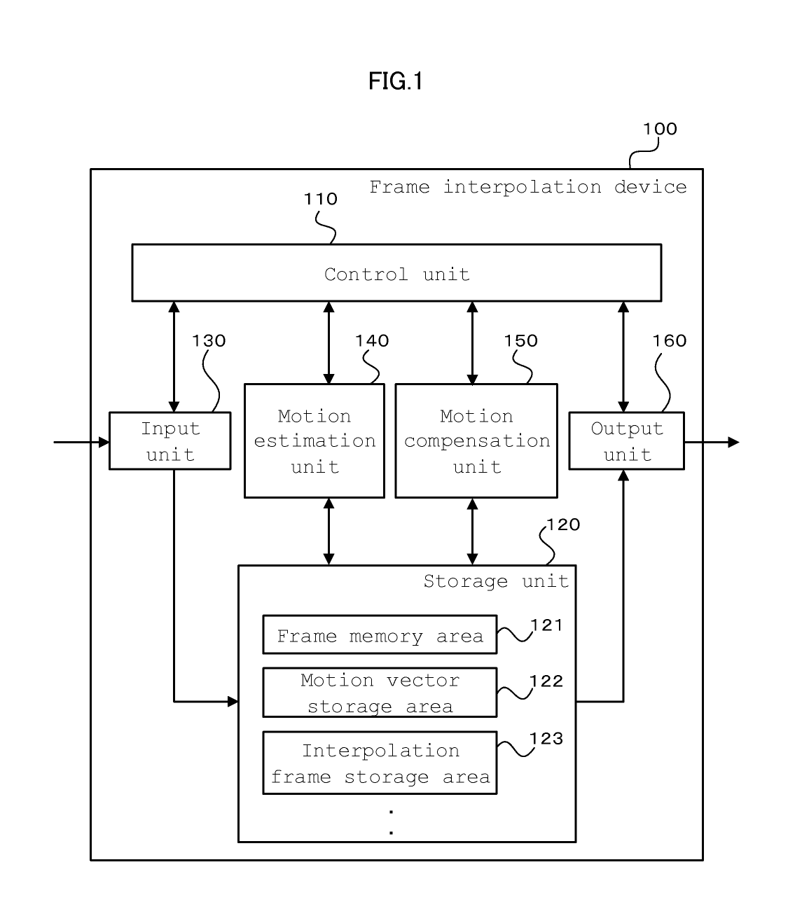

FIG. 1 is a block diagram of a frame interpolation device 100 according to the present embodiment. The frame interpolation device 100 generates frames (which will be denoted as “interpolated frame” below) to be inserted between a plurality of frames configuring a video (which will be denoted as “input frame” below). The frame interpolation device 100 includes a control unit 110, a storage unit 120, an input unit 130, a motion estimation unit 140, a motion compensation unit 150, and an output unit 160.

The control unit 110 is configured of a processing device such as processor. The control unit 110 operates according to a program stored in a ROM (Read Only Memory) or RAM (Random Access Memory) (not illustrated) thereby to control the respective units in the frame interpolation device 100.

The storage unit 120 is configured of a data readable/writable storage device such as DRAM (Dynamic Random Access Memory), SRAM (Static Random Access Memory), semiconductor memory or hard disk. The storage unit 120 includes various storage areas such as a frame memory area 121, a motion vector storage area 122 and an interpolated frame storage area 123. The frame memory area 121 stores a video signal acquired by the input unit 130 therein. The motion vector storage area 122 stores a search result generated by the motion estimation unit 140 therein. The interpolated frame storage area 123 stores an interpolated frame generated by the motion compensation unit 150 therein.

The input unit 130 is configured of an input interface such as serial interface or parallel interface. The input unit 130 stores an input video signal into the frame memory area 121. A video signal is assumed to be configured of input frames at intervals of 0.1 second, for example. In the following description, for easy understanding, the frame numbers are assumed to be assigned to the input frames as F[0], F[1], F[2], . . . in order of time.

The motion estimation unit 140 makes input frame motion estimation. The search method may use the block matching method or the gradient method, for example. The motion estimation unit 140 stores a search result of motion vectors, evaluation value or the like in the motion vector storage area 122.

The motion compensation unit 150 operates according to a program stored in the ROM or RAM (not illustrated) thereby to realize various operations including “motion compensation processing.” The motion compensation processing generates an interpolated frame based on a search result of the motion estimation unit 140. The motion compensation unit 150 stores the generated interpolated frame in the interpolated frame storage area 123. The motion compensation unit 150 may realize its function by one processor or in cooperation with a plurality of processors.

The output unit 160 is configured of an output interface such as serial interface or parallel interface. The output unit 160 outputs an interpolated frame stored in the interpolated frame storage area 123.

The operations of the frame interpolation device 100 will be described below.

The operations of the frame interpolation device 100 are divided into the “motion estimation processing” performed by the motion estimation unit 140 and the “motion compensation processing” performed by the motion compensation unit 150. The motion estimation processing will be described first.

When being ordered to start the motion estimation processing from the control unit 110, the motion estimation unit 140 starts the processing. The motion estimation unit 140 searches a motion of the image between two input frames. In the following description, it is assumed that the frame numbers of the two input frames to be searched are designated by the control unit 110 at the same time with the order of starting the motion estimation processing. At this time, the frame numbers designated by the control unit 110 are assumed as F[n−1] and F[n].

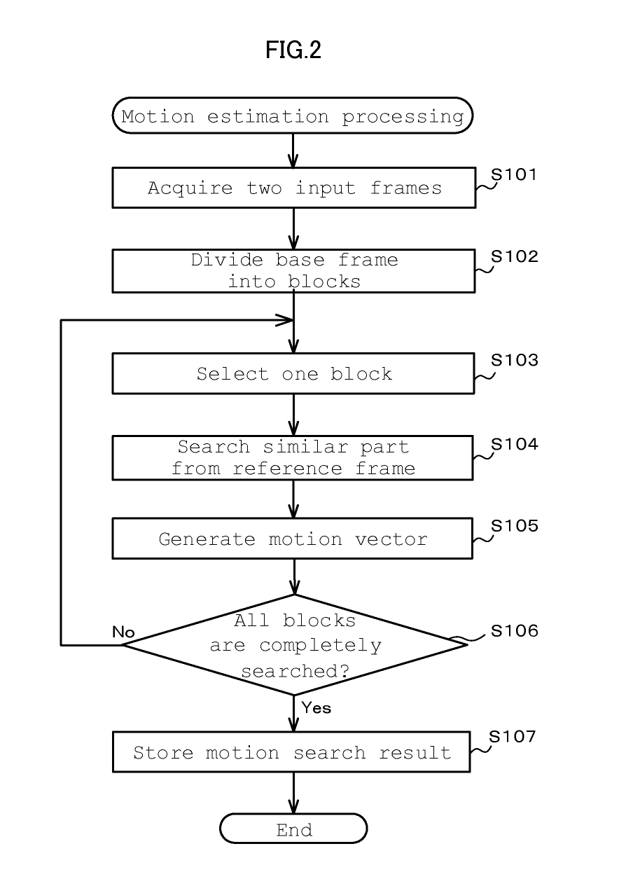

FIG. 2 is a flowchart illustrating the operations of the motion estimation unit 140. The motion estimation unit 140 acquires two designated input frames from the frame memory area 121 (S101). In the following description, the frame F[n] is called base frame and the frame F[n−1] is called reference frame.

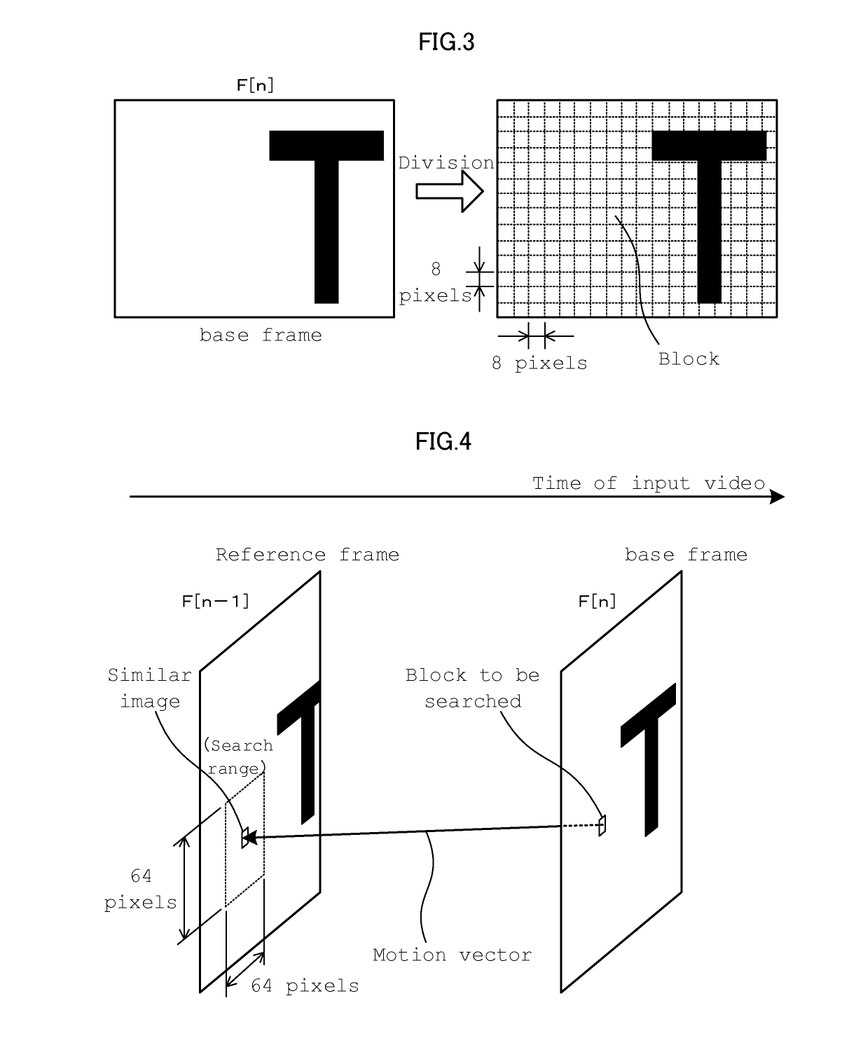

The motion estimation unit 140 divides the base frame F[n] into a plurality of blocks (S102). The block size is arbitrary. FIG. 3 illustrates an example in which the base frame F[n] is divided in a block size of 8×8.

The motion estimation unit 140 selects one unsearched block as a block to be searched from the base frame F[n] (S103).

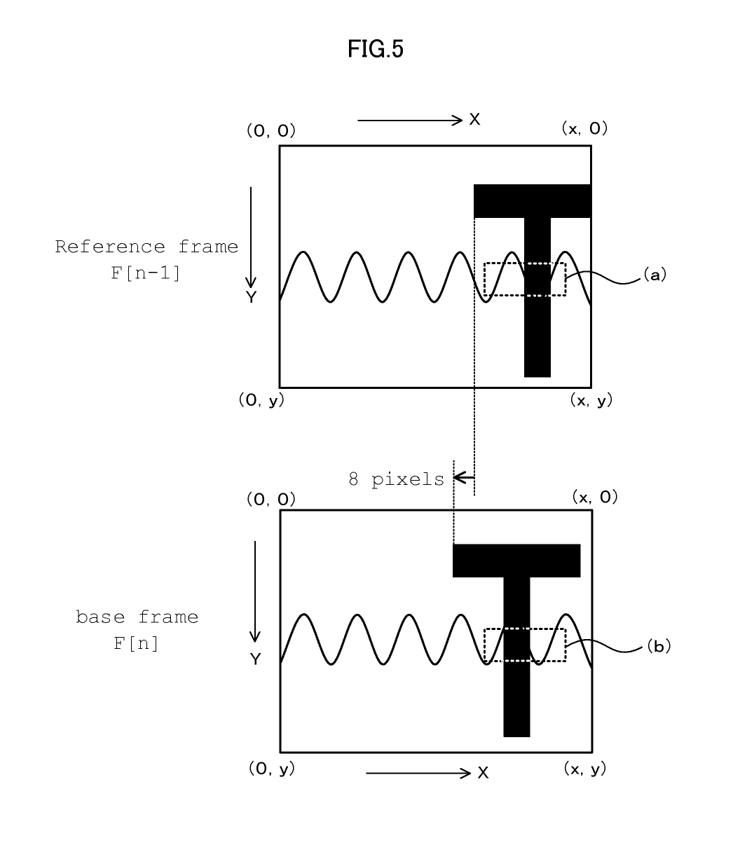

Subsequently, the motion estimation unit 140 searches a part similar to the block to be searched from the reference frame F[n−1] (S104). The search method may be a well-known search method such as the block matching method or the gradient method, or may be a search method uniquely improved by a device manufacturer. After the searching, the motion estimation unit 140 acquires an evaluation value of the part similar to the block to be searched. The evaluation value indicates a degree of coincidence between the block to be searched and the similar part. The search range of the motion estimation unit 140 may not be necessarily the total reference frame F[n−1]. The search range may be a certain range in the reference frame F[n−1] or may be a preset range about the coordinate corresponding to the block to be searched, for example. FIG. 4 illustrates an example in which the search range is 64×64 pixels.

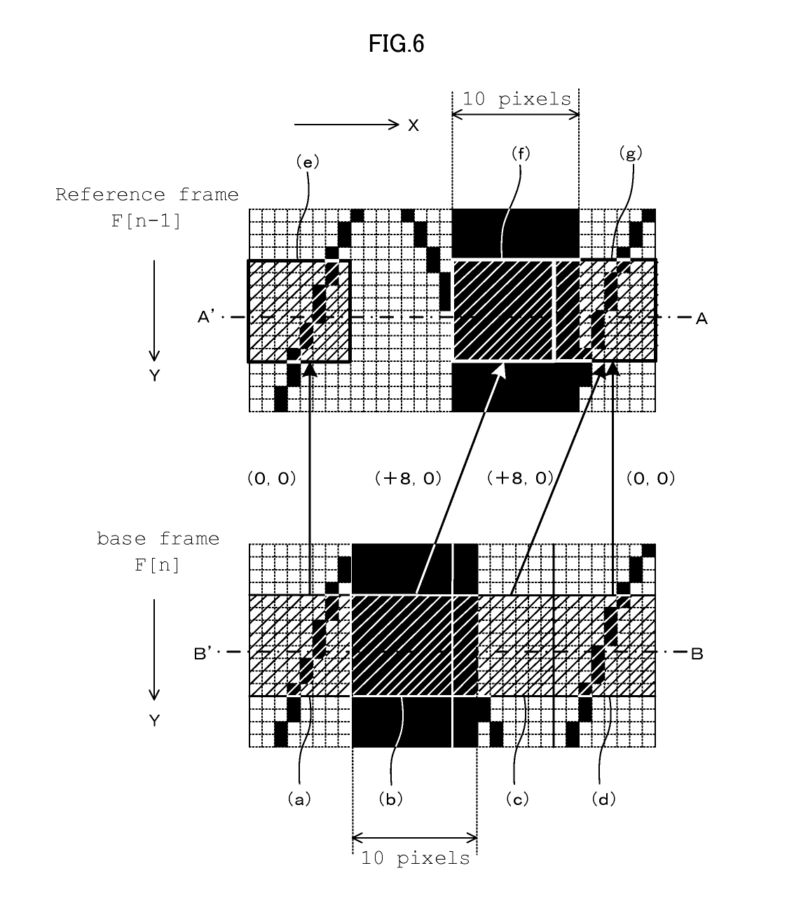

The operation in step S104 will be described herein by use of a specific example. FIG. 5 illustrates an x×y-pixel image with a wavy line on the background. FIG. 5 illustrates a character “T” moving from right to left in the figure in front of the wavy line in addition to the wavy line on the background. The character “T” moves at speed of 8 pixels per 0.1 second. FIG. 6 is a diagram in which dashed line parts illustrated in blocks (a) and (b) are enlarged, respectively, in order to easily visualize the operation in step S104. The black-colored part on the center is the vertical bar part of the character “T.” In this example, the width of the vertical bar is 10 pixels.

At first, an attention is paid to the block (a) in the base frame F[n] illustrated in FIG. 6. Part of the wavy line on the background is drawn in the block (a). The image of the block (a) completely matches with the image at the same coordinate in the reference frame F[n−1], or the image of the block (e). Thus, the motion estimation unit 140 determines that a similar part to the block (a) is the image of the block (e).

An attention is then paid to the block (b) in the base frame F[n]. Part of the character “T” moving from right to left is drawn in the block (b). The image of the block (b) completely matches with the image (block (f)) of the reference frame F[n−1] to which the block (b) moves by 8 pixels in the positive direction on the X axis. Thus, the motion estimation unit 140 determines that the similar part to the block (b) is the image of the block (f).

Subsequently, an attention is paid to the block (c) in the base frame F[n]. Part of the background hidden by the character “T” is drawn in the block (c). The background part in the block (c) is occluded behind the character “T” in the reference frame F[n−1]. Thus, image information on the background part in the block (c) is not present in the reference frame F[n−1]. However, the block (c) partially matches with the image of the block (g) in the reference frame F[n−1]. Thus, the motion estimation unit 140 determines that the similar part to the block (c) is the image of the block (g).

Finally, an attention is paid to the block (d) in the base frame F[n]. Part of the wavy line on the background is drawn in the block (d). Part of the background in the image (block (g)) in the reference frame F[n−1] at the same coordinate as the block (d) is hidden by the character “T” and the image does not completely match with the image of the block (d). However, most of the images of the block (d) and the block (g) (the background parts other than the character “T”) almost match with each other. Thus, the motion estimation unit 140 determines that the similar part to the block (d) is the image of the block (g). In the example of FIG. 6, the background is a simple wavy line only, but the background is a complicated picture in many cases. In this case, the evaluation values of the block (d) and the block (g) are higher than that in the case in which most of images do not match due to an occluded background image as in the block (c) and the block (g).

In the example of FIG. 6, the image boundaries (image boundaries of the block (e) to the block (g)) of the similar parts in the reference frame F[n−1] match with the block boundaries in the base frame F[n]. However, the image boundaries of the similar parts do not necessarily match with the block boundaries.

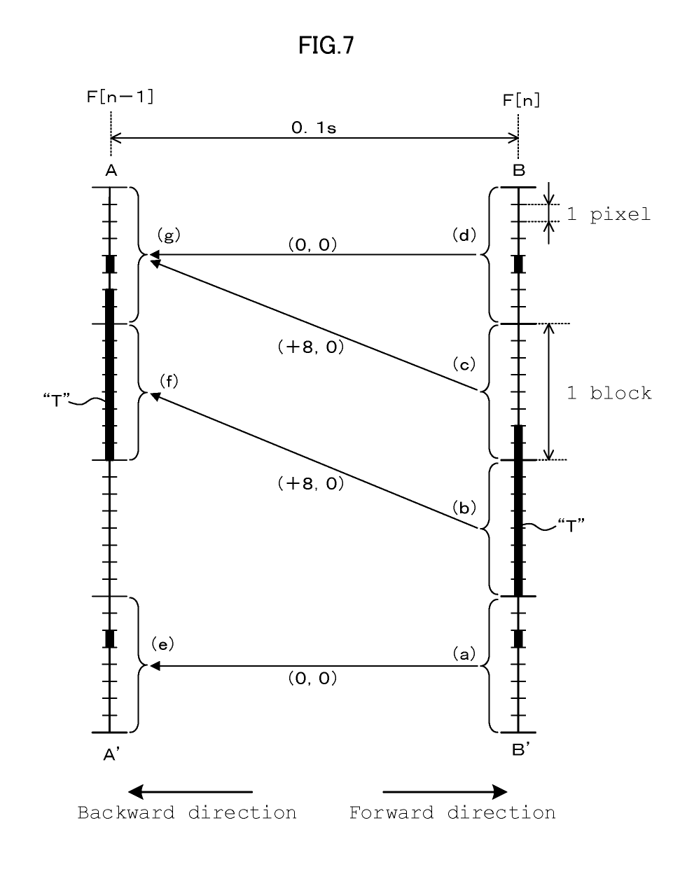

The motion estimation unit 140 generates a motion vector of the block to be searched based on the search result in S104 (S105). FIG. 7 expresses the image of FIG. 6 in an 1D form. Specifically, FIG. 7 is a diagram in which the base frame F[n] and the reference frame F[n−1] illustrated in FIG. 6 are taken along the line A-A′ and the line B-B′, respectively. The bold lines in the figure are the character “T” part and the wavy line part. As illustrated in FIG. 7, a motion vector toward the block (e) is generated for the block (a) and a motion vector toward the block (f) is generated for the block (b). The motion vectors toward the block (g) are generated for the blocks (c) and (d).

The expression form of a motion vector is not limited to a specific expression form, and various expression forms may be used. For example, a motion vector may be expressed in a coordinate form. In the example of FIG. 7, the similar parts to the block (a) and (d) are at the same coordinate positions in the reference frame F[n−1], and thus the motion vectors thereof are expressed as (0, 0). The similar parts to the blocks (b) and (c) are positioned 8 pixels away in the positive direction on the X axis, respectively, and thus the motion vectors thereof are expressed as (+8, 0). The motion estimation unit 140 stores the generated motion vectors in the RAM together with the evaluation values calculated in S104.

Subsequently, the motion estimation unit 140 determines whether search of all the blocks in the base frame F[n] are completed (step S106). When the search of all the blocks are not completed (S106: No), the motion estimation unit 140 repeats the processes in S103 to S106 until the search of all the blocks are completed. When the search of all the blocks are completed (S106: Yes), the motion estimation unit 140 proceeds to S107.

The motion estimation unit 140 associates the frame number of the base frame F[n] and the evaluation values with the motion vectors of all the blocks, and store them in the motion vector storage area 122 (S107), and then terminates the processing.

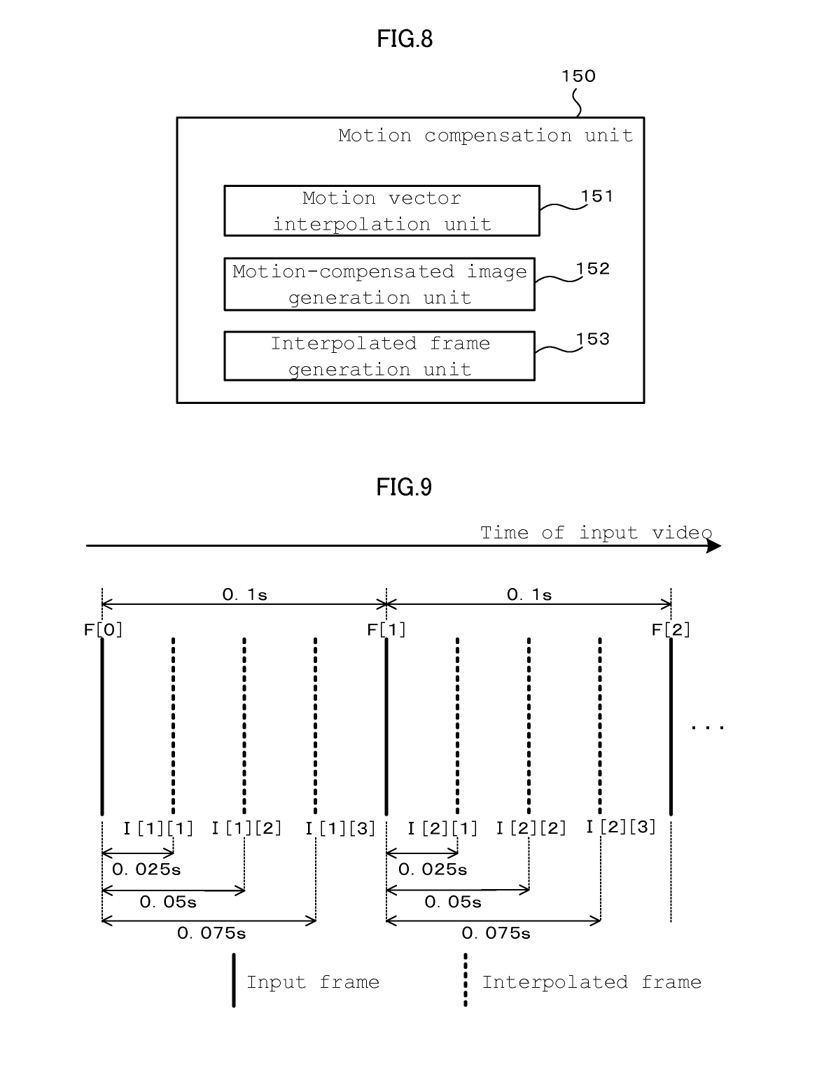

The motion compensation processing performed by the motion compensation unit 150 will be described below. FIG. 8 is a block diagram of the motion compensation unit 150. The motion compensation unit 150 performs the motion compensation processing thereby to function as a motion vector interpolation unit 151, a motion-compensated image generation unit 152, and an interpolated frame generation unit 153. In the following description, for easy understanding, a video into which the frame interpolation device 100 inserts interpolated frames is assumed to have a frame interval of 0.1 second by slow-motion playing, for example. The frame interpolation device 100 is assumed to insert three interpolated frames between two input frames at equal intervals (or at intervals of 0.025 second) as illustrated in FIG. 9, for example.

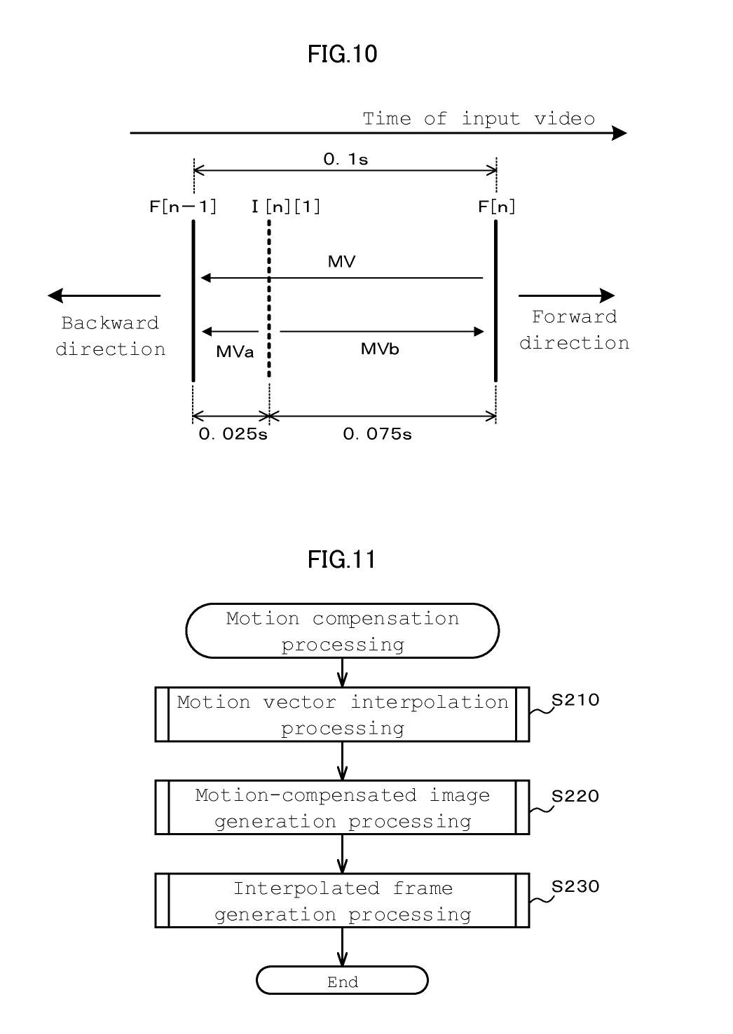

When being ordered to start the motion compensation processing from the control unit 110, the motion compensation unit 150 starts the processing. The motion compensation unit 150 generates interpolated frames to be inserted between two input frames based on the motion vectors generated in the motion estimation processing. In the following description, it is assumed that two input frames (input frames F[n] and F[n−1]) between which an interpolated frame is to be inserted, and an interpolated frame I[n][m] to be inserted are designated by the control unit 110 at the same time with the order of starting the motion estimation processing. m is an integer of 1 or more. In FIG. 9, m=1 to 3 is assumed. Further, a position where the interpolated frame I[n][m] is to be inserted is assumed to be designated by the control unit 110. The insertion position is designated as a temporal position T relative to the two input frames, for example. FIG. 10 is a diagram illustrating a relationship between the motion vector and the interpolated motion vectors. In the figure, MV indicates a motion vector, and MVa and MVb indicate an interpolated motion vector. The temporal progress direction is assumed as “forward direction” and its reverse direction is assumed as “backward direction.” In the following, the description will be made by way of an interpolated frame I[n][1]. The insertion position of the interpolated frame I[n][1] is 0.025-second advanced in the forward direction from the input frame F[n−1] as illustrated in FIG. 10. In this case, the temporal position T is 0.25 (=0.025 second/0.1 second).

FIG. 11 is a flowchart for explaining the operations of the motion compensation unit 150. The motion compensation unit 150, at first, performs a motion vector interpolation processing (S210). The motion vector interpolation processing is performed in the motion vector interpolation unit 151. The motion vector interpolation unit 151 assigns interpolated motion vectors to the interpolated frame I[n][1] based on the motion vectors generated in the motion estimation processing. The interpolated motion vectors indicate the motions of the image between the two input frames F[n], F[n−1] and the interpolated frame I[n][1].

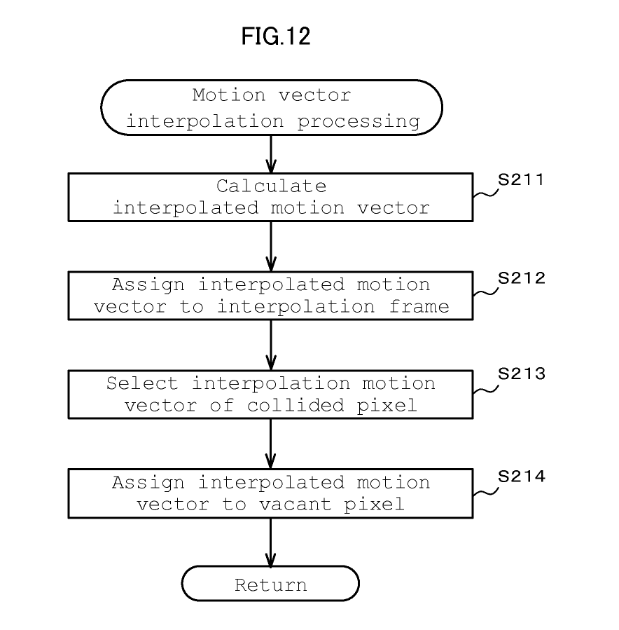

FIG. 12 is a flowchart for explaining the operations of the motion vector interpolation unit 151. The motion vector interpolation unit 151 acquires the motion vectors between the input frames F[n] and F[n−1] from the motion vector storage area 122. Then, the interpolated motion vectors are calculated per block based on the acquired motion vectors and the temporal position T of the interpolated frame I[n][1] (S211). The interpolated motion vectors are configured of a backward motion vector MVa and a forward motion vector MVb. The backward motion vector MVa is a motion vector between the input frame F[n−1] and the interpolated frame I[n][1]. The forward motion vector MVb is a motion vector between the input frame F[n] and the interpolated frame I[n][1].

Specifically, the motion vector interpolation unit 151 calculates the backward motion vector MVa and the forward motion vector MVb based on the following Equation (1) and Equation (2). In the following Equations, MV indicates a motion vector between the input frames F[n] and F[n−1], and T indicates a temporal position of the interpolated frame I[n][1] relative to the two input frames.

MVa=MV×T (1)

MVb=−MV×(1−T) (2)

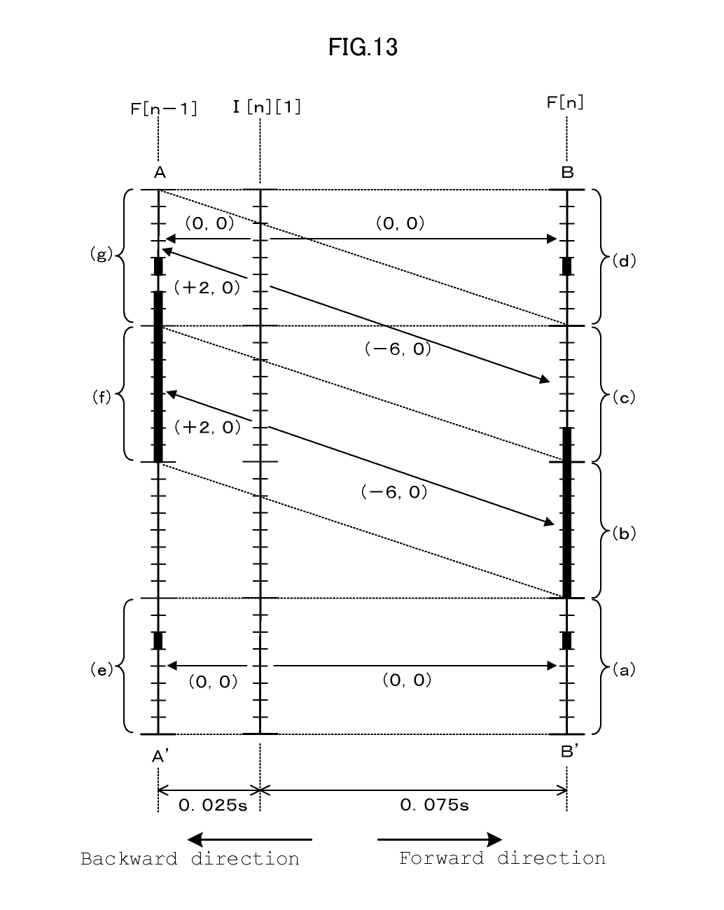

The backward motion vector MVa and the forward motion vector MVb will be described herein by way of a specific example. FIG. 13 is a diagram illustrating how interpolated motion vectors are calculated based on motion vectors between the input frames F[n] and F[n−1]. As illustrated in FIG. 7, when the motion vector MV of the block (b) is (+8, 0), the motion vector interpolation unit 151 calculates the backward motion vector MVa (+2, 0) based on Equation (1). The motion vector interpolation unit 151 calculates the forward motion vector MVb (−6, 0) based on Equation (2). The motion vector MV of the block (c) is (+8, 0), and thus the motion vector interpolation unit 151 calculates the backward motion vector MVa (+2, 0) and the forward motion vector MVb (−6, 0). The motion vectors MV of the blocks (a) and (d) are both (0, 0), and thus the motion vector interpolation unit 151 calculates both the backward motion vector MVa and the forward motion vector MVb as (0, 0).

The motion vector interpolation unit 151 assigns the interpolated motion vectors calculated in S211 to the interpolated frame I[n][1] (S212). At this time, the motion vector interpolation unit 151 assigns the interpolated motion vectors to the interpolated frame I[n][1] per unit region. The unit region may be configured of a plurality of pixels or may be configured of one pixel. The following description will be made assuming that a unit region is made of one pixel.

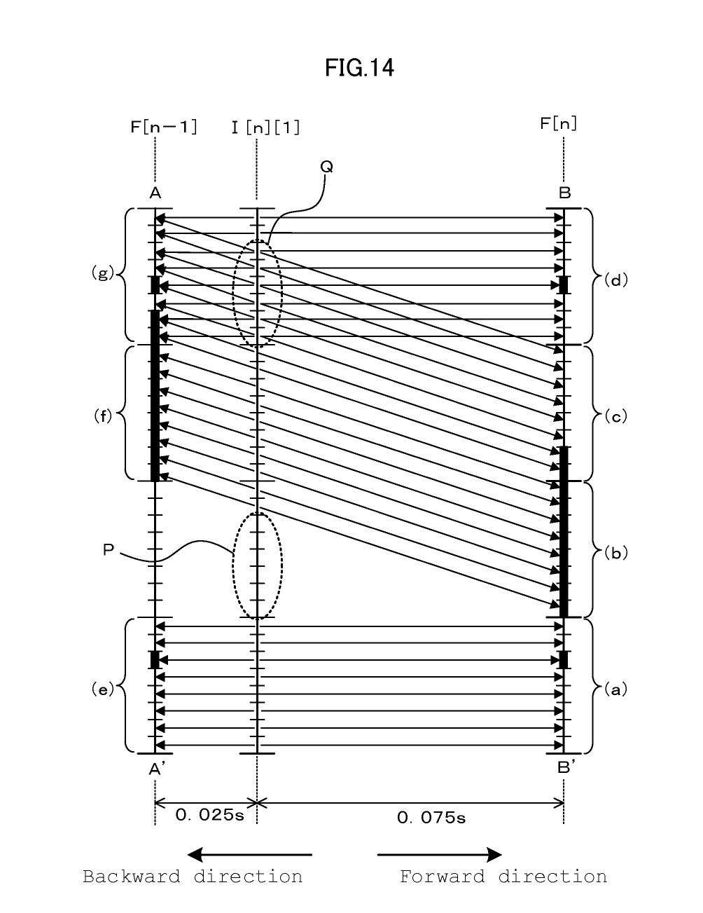

FIG. 14 is a diagram illustrating how interpolated motion vectors are assigned to the interpolated frame I[n][1] per pixel. The interpolated frame I[n][1] includes the pixels (pixels in the Q region) where a plurality of pairs of interpolated motion vectors are assigned and the pixels (pixels in the P region) where no interpolated motion vector is assigned. In the following description, a pixel where a plurality of pairs of interpolated motion vectors are assigned is called “collided pixel” and a pixel where no interpolated motion vector is assigned is called “vacant pixel.” A region configured of collided pixels is called “collided region” and a region configured of vacant pixels is called “vacant region.” Further, the collided region and the vacant region are collectively called “non-normal region.” The non-normal region may be configured of both the collided region and the vacant region or may be configured of either the collided region or the vacant region.

The motion vector interpolation unit 151 selects any one pair of interpolated motion vectors from among the assigned pairs of interpolated motion vectors for each collided pixel (S213). At this time, the motion vector interpolation unit 151 selects the interpolated motion vectors based on the evaluation value calculated by the motion estimation unit 140. Specifically, the motion vector interpolation unit 151 selects the interpolated motion vectors generated based on the motion vector MV with the largest evaluation value as interpolated motion vectors for the collided pixel.

In FIG. 14, the “interpolated motion vectors toward the block (c) and the block (g)” and the “interpolated motion vectors toward the block (d) and the block (g)” are assigned to the pixels in the collided region Q. In the example illustrated in FIG. 6, the evaluation value of the motion vector from the block (d) toward the block (g) is higher than the evaluation value of the motion vector from the block (c) toward the block (g). Therefore, the motion vector interpolation unit 151 selects the “interpolated motion vectors toward the block (d) and the block (g)” as the interpolated motion vectors for the pixels in the collided region Q.

The motion vector interpolation unit 151 assigns a pair of interpolated motion vectors to each of the vacant pixels (S214). At this time, the motion vector interpolation unit 151 assumes, as the interpolated motion vector for a vacant pixel, the interpolated motion vector which is most frequently assigned to the pixels in a preset range around the vacant pixel. For example, the motion vector interpolation unit 151 acquires the interpolated motion vectors assigned to the pixels in the 63×63-pixel range around the vacant pixel. At this time, if no interpolated motion vector is assigned to the pixels in the range, the pixels are ignored and the interpolated motion vectors are acquired from only the pixels assigned with the interpolated motion vectors. The motion vector interpolation unit 151 then most frequent interpolated motion vectors having the same value from the acquired pairs of interpolated motion vectors, and assumes the extracted interpolated motion vectors as interpolated motion vector for the vacant pixel.

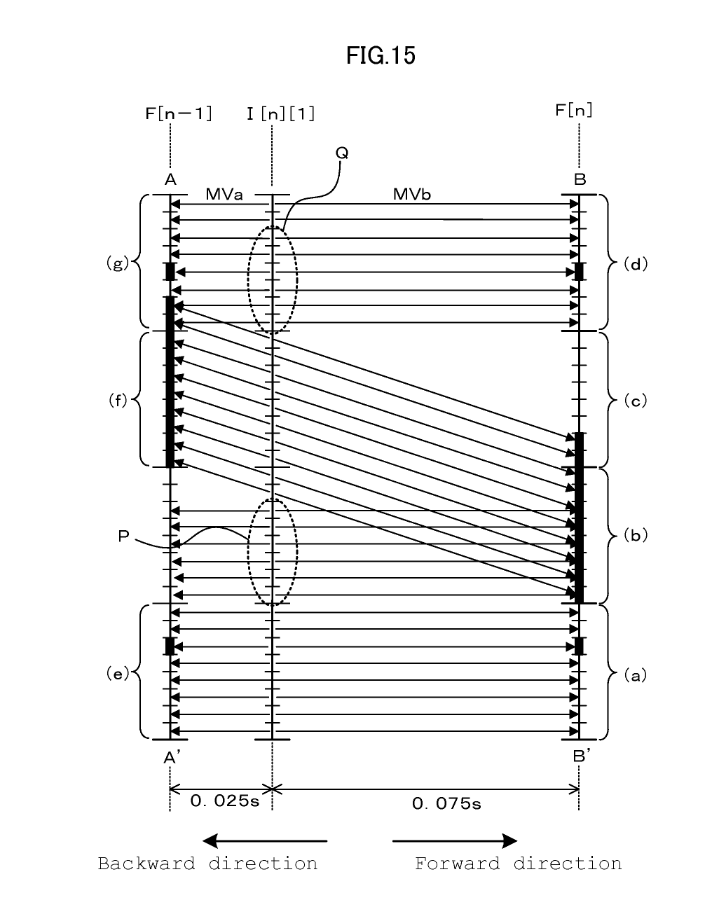

In FIG. 14, no interpolated motion vector is assigned to the pixels in the vacant region P. Generally, the largest part of a video is background part. Thus, also in FIG. 14, it is assumed that most pixels around the vacant region P are background pixels. In this case, since the background part is not moving, most pixels around the vacant region P have the motion vector (0, 0) indicating no motion are present. The forward interpolated motion vector MVb (0, 0) and the backward interpolated motion vector MVa (0, 0) are generated as interpolated motion vectors from the motion vector (0, 0). The motion vector interpolation unit 151 assigns the forward interpolated motion vector MVb (0, 0) and the backward interpolated motion vector MVa (0, 0) to the pixels in the vacant region P. FIG. 15 is a diagram illustrating how the interpolated motion vectors are assigned to the interpolated frame by the motion vector interpolation processing.

When completing the processing of interpolating the motion vectors in S210, the motion compensation unit 150 performs a motion-compensated image generation processing (S220). The motion vector interpolation processing is performed by the motion-compensated image generation unit 152. The motion-compensated image generation unit 152 generates a motion-compensated image based on the interpolated motion vectors generated in the motion vector interpolation processing. The “motion-compensated image” is an image used in the interpolated frame generation processing, and is configured of a forward motion-compensated image and a backward motion-compensated image.

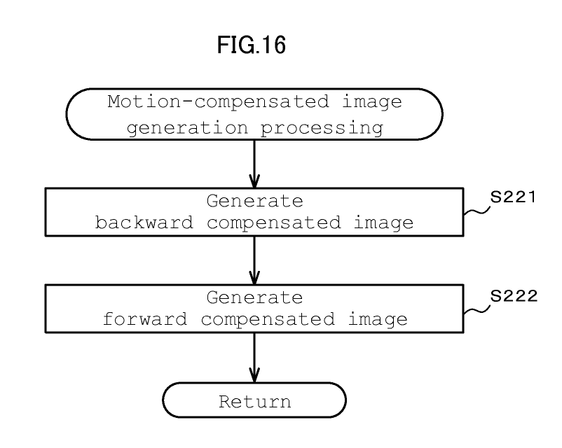

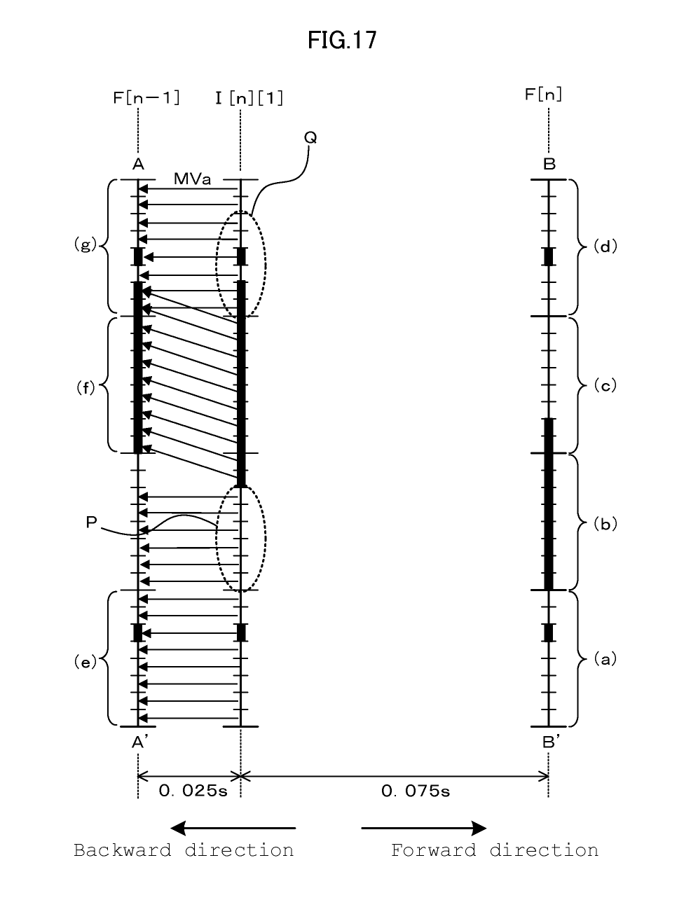

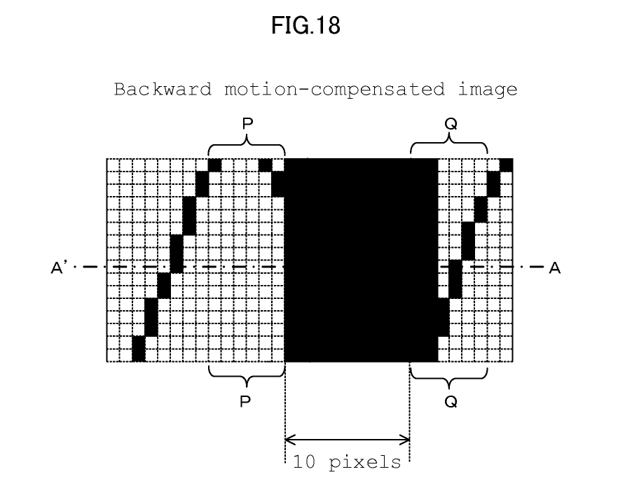

FIG. 16 is a flowchart for explaining the operations of the motion-compensated image generation unit 152. The motion-compensated image generation unit 152 generates a backward motion-compensated image based on the image information on the input frame F[n−1] backward from the interpolated frame I[n][1], and the backward interpolated motion vectors MVa (S221). The motion-compensated image generation unit 152 generates a backward motion-compensated image by attaching the pixels on the head of the arrows of the backward interpolated motion vectors MVa to the original coordinates of the arrows. FIG. 17 illustrates how a backward motion-compensated image is generated. In this case, a backward motion-compensated image to be generated is an image as illustrated in FIG. 18, for example. It can be seen that the width of the vertical bar of the 10-pixel character “T” spreads toward the collided region Q.

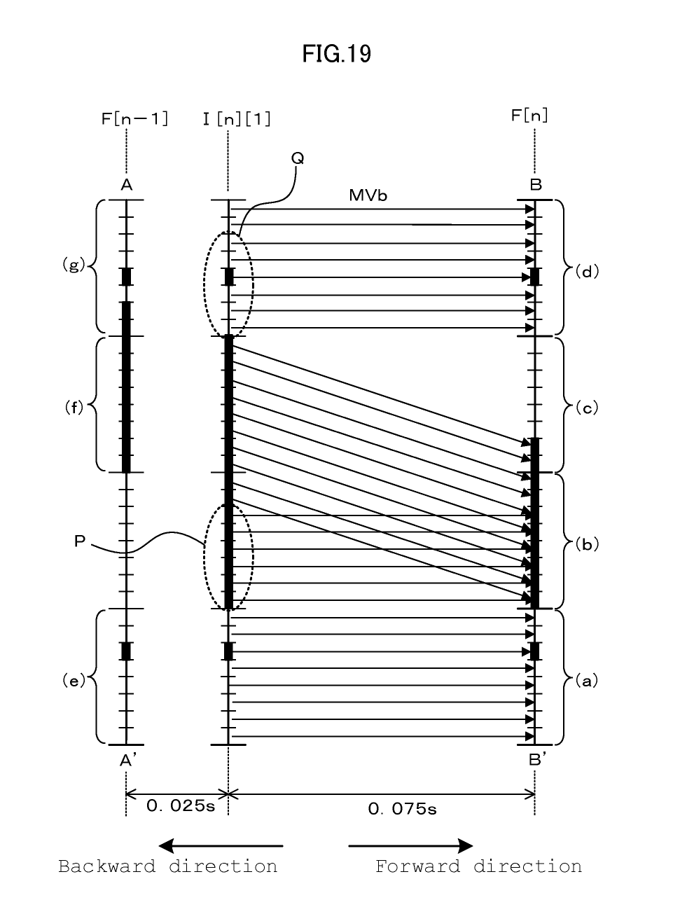

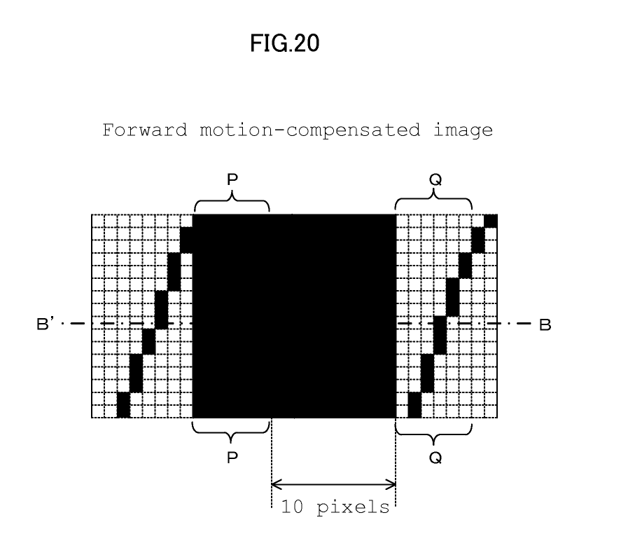

The motion-compensated image generation unit 152 generates a forward motion-compensated image based on the image information on the input frame F[n] forward from the interpolated frame I[n][1], and the forward interpolated motion vectors MVb (S222). The motion-compensated image generation unit 152 generates a forward motion-compensated image by attaching the pixels on the head of the arrows of the forward interpolated motion vectors MVb to the originating coordinates of the arrows. FIG. 19 illustrates how a forward motion-compensated image is generated. In this case, a forward motion-compensated image to be generated is an image as illustrated in FIG. 20, for example. It can be seen that the width of the vertical bar of the 10-pixel character “T” spreads toward the vacant region P.

When completing the generation of the motion-compensated image in S220, the motion compensation unit 150 performs an interpolated frame generation processing (S230). The interpolated frame generation processing is performed by the interpolated frame generation unit 153 illustrated in FIG. 8. The interpolated frame generation unit 153 averages two motion-compensated images generated in the motion-compensated image generation processing thereby to generate an interpolated frame I[n][1] to be inserted between the two input frames.

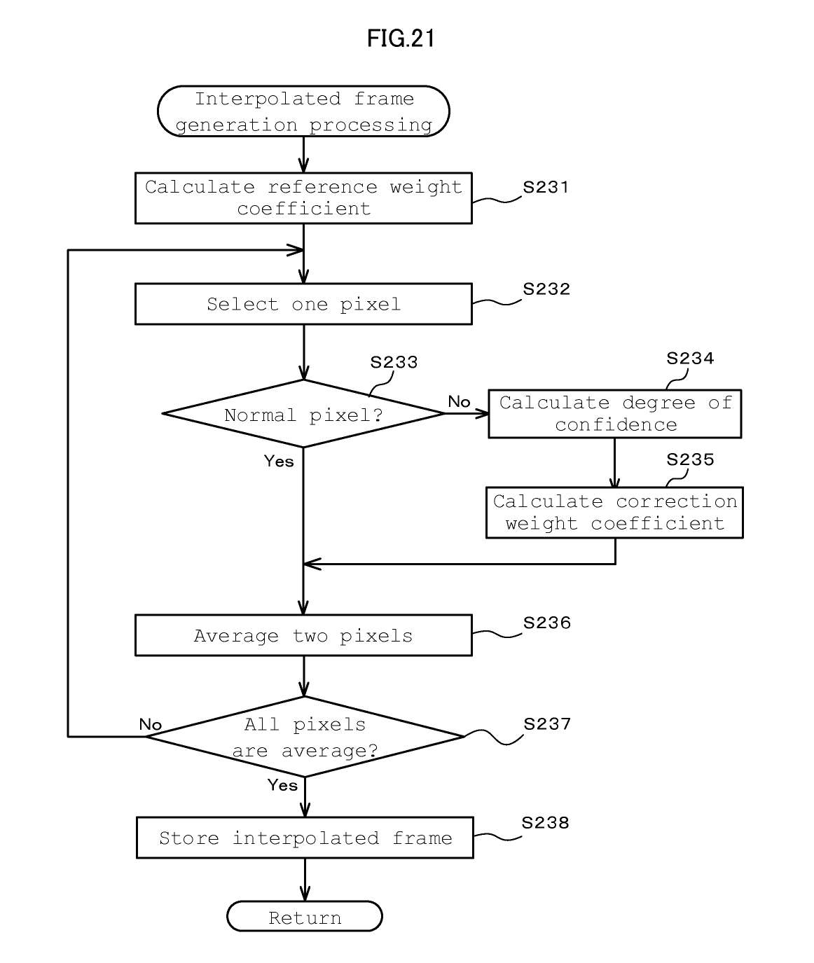

FIG. 21 is a flowchart for explaining the operations of the interpolated frame generation unit 153. The interpolated frame generation unit 153, at first, calculates a reference weight coefficient Wr (S231). The reference weight coefficient Wr is used for averaging normal regions in the two motion-compensated images. The “normal region” is configured of a normal pixel to which only one pair of interpolated motion vectors is assigned. The reference weight coefficient Wr is a numerical value between 0 and 1. The weight on the backward motion-compensated image is strengthened, the reference weight coefficient Wr approaches 0, and when the weight on the forward motion-compensated image is strengthened, the reference weight coefficient Wr approaches 1. The interpolated frame generation unit 153 calculates a reference weight coefficient Wr based on the insertion position of the interpolated frame I[n][1]. Specifically, the interpolated frame generation unit 153 calculates a reference weight coefficient Wr based on the temporal position T of the interpolated frame I[n][1]. In the present embodiment, the temporal position T takes a numerical value between 0 and 1, and thus the interpolated frame generation unit 153 calculates the temporal position T as a reference weight coefficient Wr as it is.

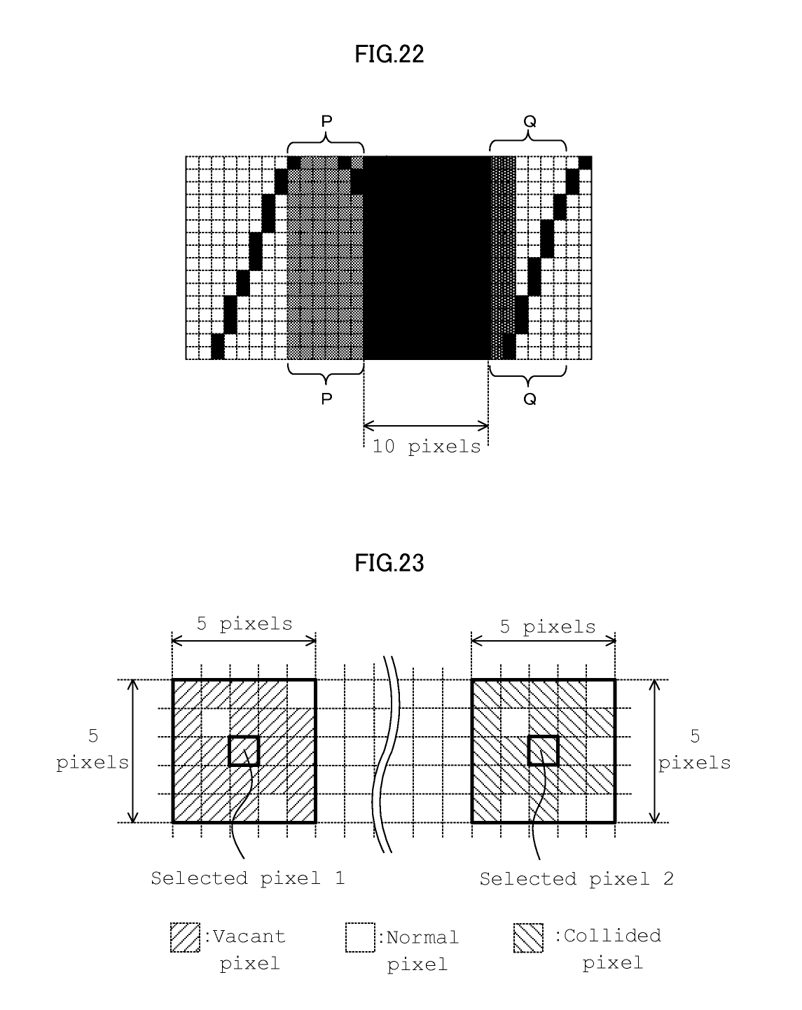

FIG. 22 illustrates an image which is obtained by averaging the backward motion-compensated image illustrated in FIG. 18 and the forward motion-compensated image illustrated in FIG. 20 by the reference weight coefficient Wr. When all the regions are averaged by use of the reference weight coefficient Wr, an afterimage which should not be present may clearly appear in the non-normal regions (the vacant region P and the collided region Q). Thus, the interpolated frame generation unit 153 averages the image by use of different weight coefficients between the normal region and the non-normal region in S232 to S237.

At first, the interpolated frame generation unit 153 selects one pixel which has not been assigned with a pixel value from among a plurality of pixels configuring the interpolated frame I[n][1] (S232).

The interpolated frame generation unit 153 determines whether the pixel selected in S232 (which will be denoted as “selected pixel” below) is a normal pixel (S233). When the selected pixel is a normal pixel (S233: Yes), the interpolated frame generation unit 153 proceeds to S236. When the selected pixel is not a normal pixel (S233: No) or when the selected pixel is a collided pixel or vacant pixel, the interpolated frame generation unit 153 proceeds to S234.

When the selected pixel is not a normal pixel (S233: No), the interpolated frame generation unit 153 calculates a degree of confidence indicating a possibility that the selected pixel is an occlusion region (S234). The occlusion region is where an object overlaps the background behind the object or another object and the background behind the object or another object cannot be temporarily seen. In the example of FIG. 6, the character “T” parts in the base frame F[n] and the reference frame F[n−1] are occlusion regions.

Specifically, the interpolated frame generation unit 153 calculates a degree of confidence Ap or a degree of confidence Aq based on the following Equation (3) and Equation (4). The degree of confidence Ap is a degree of confidence when the selected pixel is a vacant pixel, and the degree of confidence Aq is a degree of confidence when the selected pixel is a collided pixel.

Ap=Rp (3)

Aq=Rq (4)

Here, Rp is a rate of the vacant pixels occupying the neighboring pixels around the selected pixel, and Rq is a rate of the collided pixels occupying the neighboring pixels around the selected pixel. The neighboring pixels are positioned in a preset range determined with reference to the selected pixel. FIG. 23 is a diagram illustrating exemplary neighboring pixels. The neighboring pixels are 24 pixels in the 5×5-pixel square range around the selected pixel, for example. In FIG. 23, 21 vacant pixels among the 24 pixels around the selected pixel 1 are present, and thus Rp is calculated as 0.875 (=21/24). 18 collided pixels among the 24 pixels around the selected pixels 2 are present, and thus Rq is calculated as 0.75 (=18/24).

Subsequently, the interpolated frame generation unit 153 calculates a correction weight coefficient based on the calculated degree of confidence Ap or degree of confidence Aq (S235). The correction weight coefficient is used for averaging the non-normal regions in the two motion-compensated images. The interpolated frame generation unit 153 calculates a correction weight coefficient based on a reference weight coefficient Wr. Specifically, the interpolated frame generation unit 153 shifts the weight toward either the forward motion-compensated image or the backward motion-compensated image with reference to the value of the reference weight coefficient Wr thereby to calculate a correction weight coefficient.

Generally, the vacant region P is assumed as a background region which is gradually hidden by a moving object. Thus, it is assumed that when the image of the vacant region P is to be generated, it should be based on the backward image F[n−1] so that a more natural image can be generated. On the other hand, the collided region Q is assumed as a region where the background hidden by a moving object is appearing. Thus, it is assumed that when the image of the collided region Q is to be generated, it should be based on the forward image F[n] so that a more natural image can be generated. Thus, when the selected pixel is a vacant pixel, the interpolated frame generation unit 153 shifts the weight toward the backward motion-compensated image with reference to the reference weight coefficient Wr, and when the selected pixel is a collided pixel, it shifts the weight toward the forward motion-compensated image with reference to the reference weight coefficient Wr.

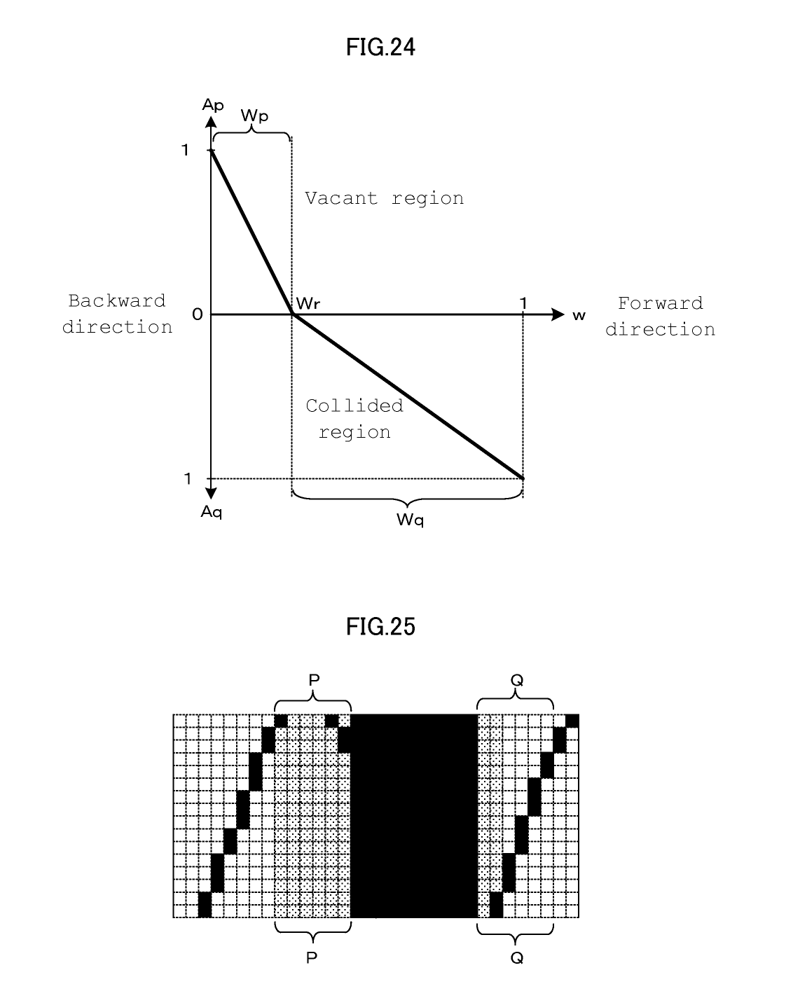

In this case, the interpolated frame generation unit 153 linearly changes the value toward 0 or 1 with reference to the reference weight coefficient Wr in order to smooth a change in the appearing afterimage. FIG. 24 is a diagram illustrating a relationship between a degree of confidence and a weight coefficient. More specifically, the interpolated frame generation unit 153 calculates a correction weight coefficient Wp or a correction weight coefficient Wq based on the following Equation (5) and Equation (6). Wp is a correction weight coefficient used for averaging the vacant regions, and Wq is a correction weight coefficient used for averaging the collided regions.

Wp=Wr×(1−Ap) (5)

Wq=Wr×(1−Aq)+Aq (6)

The interpolated frame generation unit 153 weight-averages the pixels at the same coordinate between the backward motion-compensated image and the forward motion-compensated image thereby to calculate a pixel value V of the selected pixel in the interpolated frame I[n][1] (S236). Specifically, the interpolated frame generation unit 153 calculates the pixel value V of the selected pixel in the interpolated frame I[n][1] based on the following Equation (7) to Equation (9). Equation (7) is used when the selected pixel is a vacant pixel, and Equation (8) is used when the selected pixel is a collided pixel. Equation (9) is used when the selected pixel is a normal pixel.

V=Va×(1−Wp)+Vb×Wp (7)

V=Va×(1−Wq)+Vb×Wq (8)

V=Va×(1−Wr)+Vb×Wr (9)

Va is a pixel value of the selected pixel in the backward motion-compensated image and Vb is a pixel value of the selected pixel in the forward motion-compensated image. When completing the calculation of the pixel value V, the interpolated frame generation unit 153 assigns the pixel value V to the selected pixel in the interpolated frame.

Subsequently, the interpolated frame generation unit 153 determines whether all the pixels are averaged (S237). When all the pixels have not been averaged (S237: No), the interpolated frame generation unit 153 returns to S232 and repeats S232 to S237 until all the pixels are averaged. When all the pixels are averaged (S237: Yes), the interpolated frame generation unit 153 proceeds to S238.

When all the pixels are averaged (S237: Yes), the interpolated frame generation unit 153 stores the interpolated frame I[n][1] assigned with the pixel value in the interpolated frame storage area 123 (S238). In the examples illustrated in FIG. 18 and FIG. 20, the image stored in the interpolated frame storage area 123 is lighter in its afterimages of the non-normal regions (the vacant region P and the collided region Q) than the image when the correction weight coefficient is not shifted, illustrated in FIG. 22.

When completing the storage of the interpolated frame, the motion compensation unit 150 terminates the motion compensation processing. The control unit 110 transmits the interpolated frame I[n][1] stored in the interpolated frame storage area 123 to an external device as needed.

According to the present embodiment, the image is averaged by use of different weights between the normal regions and the non-normal regions, and thus an unnatural afterimage occurring in an occlusion region, particularly an unnatural afterimage occurring near a boundary between a moving object and the background can be lighter. Additionally, the frame interpolation device 100 shifts the weight used for averaging the vacant regions toward the backward motion-compensated image, and thus can generate a natural image in the region where the background is gradually hidden in the occlusion region. Further, the frame interpolation device 100 shifts the weight used for averaging the collided regions toward the forward motion-compensated image, and thus can generate a natural image in the region where the background appears in the occlusion region.

The frame interpolation device 100 calculates a correction weight coefficient based on a rate of vacant pixels or collided pixels occupying the neighboring pixels around the selected pixel. More specifically, a correction weight coefficient is calculated based on the degree of confidence Ap calculated based on the rate of vacant pixels occupying the neighboring pixels or the degree of confidence Aq calculated based on the rate of collided pixels occupying the neighboring pixels. Small vacant regions or collided regions may be dispersed in an image of a video in which the objects or the background does not move perfectly in parallel. When the selected pixel is a vacant pixel or collided pixel dispersed in the image and thus not a pixel in an occlusion region, the degree of confidence or the rate has a low value, and consequently the correction weight coefficient is considered to have a value close to the reference weight coefficient. Therefore, when the selected pixel is a vacant pixel or collided pixel dispersed in the image, the frame interpolation device 100 can average the selected pixels of the two motion-compensated images with the weight coefficient close to the reference weight coefficient so that a pixel with a remarkably different value from the neighboring pixel values is less likely to occur in the interpolated frame. Consequently, the frame interpolation device 100 can generate a more natural interpolated frame.

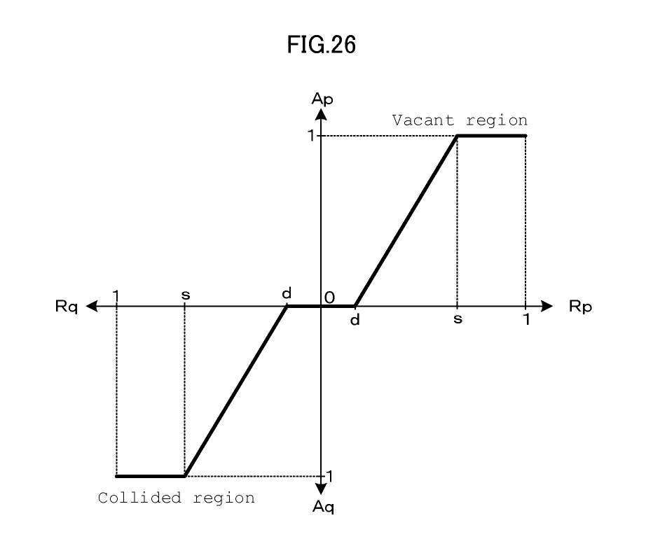

The above embodiment is merely exemplary, and various modifications and applications can be made thereto. For example, the rate Rp of the vacant pixels occupying the neighboring pixels is acquired as the degree of confidence Ap in the above embodiment, but the value of the degree of confidence Ap does not necessarily match with the rate Rp. For example, when the rate Rp is larger than a preset value s, the interpolated frame generation unit 153 may assume the selected pixel as a pixel in the occlusion region and set the degree of confidence Ap at 1. FIG. 26 is a diagram illustrating an exemplary relationship between a rate of neighboring pixels and a degree of confidence. The interpolated frame generation unit 153 then calculates the correction weight coefficient Wp based on Equation (5). Thereby, when the selected pixel is likely to be a pixel in the occlusion region, the pixels of the backward compensated image can be assumed as the pixels of the interpolated frame as it is, and thus the interpolated frame generation unit 153 can make the afterimage even lighter. Consequently, the interpolated frame generation unit 153 can generate a more natural interpolated frame.

Further, when the rate Rp is smaller than a preset value d, the frame interpolation device 100 may assume the selected pixel as not a pixel in the occlusion region but a vacant pixel dispersed in the image and set the degree of confidence Ap at 0. The interpolated frame generation unit 153 then calculates a correction weight coefficient Wp based on Equation (5). Thereby, when the selected pixel is likely to be a vacant pixel dispersed in the image not a pixel in the occlusion region, the pixel value calculated by use of the reference weight coefficient Wr can be assumed as the value of the selected pixel in the interpolated frame, and thus the pixel value of the selected pixel can be close to the neighboring pixel values. Consequently, the interpolated frame generation unit 153 can generate a more natural interpolated frame.

In the above embodiment, the rate Rq of the collided pixels occupying the neighboring pixels is acquired as the degree of confidence Aq, but the value of the degree of confidence Aq does not necessarily match with the rate Rq. For example, when the rate Rq is larger than the preset value s, the frame interpolation device 100 may assume the selected pixel as a pixel in the occlusion region and set the degree of confidence Ap at 1. The interpolated frame generation unit 153 then calculates a correction weight coefficient Wq based on Equation (6). Thereby, when the selected pixel is likely to be a pixel in the occlusion region, the pixels in the forward compensated image can be assumed as the pixels of the interpolated frame, and thus the interpolated frame generation unit 153 can make an afterimage occurring in the interpolated frame lighter. Consequently, the interpolated frame generation unit 153 can generate a more natural interpolated frame.

When the rate Rq is smaller than the preset value d, the frame interpolation device 100 may assume the selected pixel as a collided pixel dispersed in the image not a pixel in the occlusion region and set the degree of confidence Aq at 0. The interpolated frame generation unit 153 then calculates a correction weight coefficient Wq based on Equation (6). Thereby, when the selected pixel is likely to be a collided pixel dispersed in the image not a pixel in the occlusion region, the pixel value calculated by use of the reference weight coefficient Wr can be assumed as the value of the selected pixel of the interpolated frame, and thus the pixel value of the selected pixel can be closer to the neighboring pixel values. Consequently, the interpolated frame generation unit 153 can generate a more natural interpolated frame.

The neighboring pixels are assumed to be in the 5×5 square range around the selected pixel in the above embodiment, but the range of the neighboring pixels is not limited to the 5×5 square range. The range of the neighboring pixels is not limited to a square range, and the range of the neighboring pixels may be a quadrangular range such as rectangular shape or rhombic shape around the selected pixel, for example. Further, the range of the neighboring pixels is not limited to a quadrangular shape, and may be a circular or oval range, for example. Furthermore, the position of the selected pixel may not be on the center of the range. For example, the selected pixel may be positioned at an end of the range.

In the above embodiment, the interpolated frame generation unit1 153 shifts the weight toward the backward motion-compensated image when the selected pixel is a vacant pixel, but the shift direction is not limited to the backward direction. The interpolated frame generation unit 153 may shift the weight toward the forward motion-compensated image as needed depending on the nature of the video.

In the above embodiment, the interpolated frame generation unit 153 shifts the weight toward the forward motion-compensated image when the selected pixel is a collided pixel, but the shift direction is not limited to the forward direction. The interpolated frame generation unit 153 may shift the weight toward the backward motion-compensated image as needed depending on the nature of the video.

In the above embodiment, the input frames to be used for generating an interpolated frame are assumed as input frames F[n−1] and F[n] immediately before and immediately after the interpolated frame, but the input frames to be used for generating an interpolated frame are not limited to those immediately before and immediately after input frames. The input frames may be separated away from the interpolated frame by 2 or more frames.

In the above embodiment, the interpolated frame generation unit 153 calculates a reference weight coefficient Wr based on the temporal position T of the interpolated frame, but the interpolated frame generation unit 153 may calculate a reference weight coefficient Wr without using the temporal position T. For example, the interpolated frame generation unit 153 may assume the reference weight coefficient Wr at 0.5 uniformly, and simply average the normal regions uniformly.

In the above embodiment, the description has been made assuming that a unit region is made of one pixel, but the unit region may be configured of a plurality of pixels. In this case, the vacant pixel, the collided pixel and the non-normal pixel can be denoted as vacant unit region, collided unit region and non-normal unit region, respectively. The vacant unit region is a concept including a vacant pixel, and the collided unit region is a concept including a collided pixel. The non-normal unit region is a concept including a non-normal pixel.

In the above embodiment, the motion compensation unit 150 completes to generate motion-compensated images (a backward motion-compensated image and a forward motion-compensated image) in the motion-compensated image generation processing and then performs the interpolated frame generation processing, but the motion compensation unit 150 may perform the interpolated frame generation processing before completing the generation of motion-compensated images. The motion compensation unit 150 may generate an interpolated frame by repeating the generation of a motion-compensated image in a certain range (a motion-compensated image for one block, for example) and the generation of an interpolated frame in a certain range (an interpolated frame for one block, for example). The motion compensation unit 150 may generate an interpolated frame by repeating the generation of a motion-compensated image for one pixel and the generation of an interpolated frame for one pixel.

The above embodiment has been described assuming that the interpolated motion vectors are configured of a pair of interpolated motion vectors including a backward interpolated motion vector MVa and a forward interpolated motion vector MVb, but the interpolated motion vectors may not be necessarily configured of a pair of interpolated motion vectors. The interpolated motion vectors may be configured of either a backward interpolated motion vector MVa or a forward interpolated motion vector MVb. In this case, the interpolated motion vector may be such that one interpolated motion vector is specified as needed based on the information on the other interpolated motion vector of either a backward interpolated motion vector MVa or a forward interpolated motion vector MVb and the information on the motion vector MV.

The above embodiment has been described assuming that a video into which the frame interpolation device 100 inserts interpolated frames is a slow-motion playing video, but a video into which the frame interpolation device 100 inserts interpolated frames is not limited to a slow-motion playing video. For example, a video into which the frame interpolation device 100 inserts interpolated frames may be a video played at a normal speed.

In the above embodiment, the frame interpolation device 100 is configured to output generated interpolated frames to an external device, but the frame interpolation device 100 may be configured to include a playing function and to output a video generated based on generated interpolated frames and input frames to a display device. In this case, the frame interpolation device 100 may be configured to be able to output a video signal from the output unit 160, or may be configured to include a display unit for displaying a video and to output a video to the display unit. Of course, the frame interpolation device 100 may not include a video playing function and may only generate interpolated frames.

The frame interpolation device 100 can be assumed as a product such as TV, recorder, personal computer, fixed-line telephone, cell phone, Smartphone, tablet terminal, PDA (Personal Digital Assistant) or game machine. Alternatively, the frame interpolation device 100 can be assumed as a component mounted on a product, such as semiconductor or semiconductor circuit board.

The frame interpolation device 100 according to the present embodiment may be realized by a dedicated system or may be realized by a typical computer system. For example, a program for performing the above operations may be stored in a computer readable storage medium such as optical disk, semiconductor memory, magnetic tape or flexible disk to be distributed and the program may be installed in a computer to perform the above processing thereby to configure the frame interpolation device 100. The program may be stored in a disk device provided in a server device on a network such as Internet and downloaded in a computer. The above functions may be realized in cooperation with the OS (Operating System) and application software. In this case, the components other than the OS may be stored in a medium to be distributed, or the components other than the OS may be stored in a server device to be downloaded in a computer.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form o the apparatus and methods described herein may be made without departing from the spirit of the inventions. The accompanying claims and there equivalents are intended to cover such forms of modifications as would fall within the scope and spirit of the invention.

What is claimed is:

1. A frame interpolation device comprising:
a motion vector interpolation unit that, based on motion vectors indicating motions of an image between two frames and a temporal position of an interpolated frame inserted between the two frames, calculates interpolated motion vectors indicating motions of images between the interpolated frame and the two frames, and assigns the calculated interpolated motion vectors to the interpolated frame per unit region;
a motion-compensated image generation unit that generates a forward motion-compensated image generated based on image information on the forward frame out of the two frames and the interpolated motion vectors, and a backward motion-compensated image generated based on image information on the backward frame out of the two frames and the interpolated motion vectors; and
an interpolated frame generation unit that generates the interpolated frame by averaging corresponding regions of the forward motion-compensated image and the backward motion-compensated image by different weights between a normal region in which one or one pair of interpolated motion vectors is assigned per unit region and a non-normal region which is configured of at least one of a collided region assigned with a plurality or a plurality of pairs of interpolated motion vectors per unit region and a vacant region assigned with no interpolated motion vector.

2. The frame interpolation device according to claim 1,
wherein the interpolated frame generation unit weight-averages the non-normal region of the forward motion-compensated image and the non-normal region of the backward motion-compensated image based on a correction weight coefficient calculated by shifting a weight to either one of the side of the forward motion-compensated image and the backward motion-compensated image with reference to a reference weight coefficient value which is a weight coefficient used for averaging the normal regions.

3. The frame interpolation device according to claim 2,
wherein the non-normal region includes the vacant region, and
the interpolated frame generation unit weight-averages the vacant region of the forward motion-compensated image and the vacant region of the backward motion-compensated image based on the correction weight coefficient calculated by shifting a weight to the side of the backward motion-compensated image with reference to the reference weight coefficient value.

4. The frame interpolation device according to claim 2,
wherein the non-normal region includes the collided region, and
the interpolated frame generation unit weight-averages the collided region of the forward motion-compensated image and the collided region of the backward motion-compensated image based on the correction weight coefficient calculated by shifting a weight to the side of the forward motion-compensated image with reference to the reference weight coefficient value.

5. The frame interpolation device according to claim 2,
wherein the non-normal region is configured of the vacant region and the collided region, and
the interpolated frame generation unit weight-averages the vacant region of the forward motion-compensated image and the vacant region of the backward motion-compensated image based on the correction weight coefficient calculated by shifting a weight to the backward motion-compensated image with reference to the reference weight coefficient value, and
weight-averages the collided region of the forward motion-compensated image and the collided region of the backward motion-compensated image based on the correction weight coefficient calculated by shifting a weight to the forward motion-compensated image with reference to the reference weight coefficient value.

6. The frame interpolation device according to claim 2,
wherein the non-normal region includes the vacant region, and
the interpolated frame generation unit determines whether each of the unit regions in the interpolated frame is a vacant unit region having assigned with no interpolated motion vector,
calculates a rate of the vacant unit regions occupying the unit regions present in a preset range with reference to the positions of the vacant unit regions for each of the unit regions determined as the vacant unit region,
calculates the correction weight coefficient for each of the vacant unit regions by correcting the reference weight coefficient based on the rate, and
weight-averages the vacant region of the forward motion-compensated image and the vacant region of the backward motion-compensated image based on the calculated correction weight coefficient.

7. The frame interpolation device according to claim 2,
wherein the non-normal region includes the collided region, and
the interpolated frame generation unit determines whether each of the unit regions in the interpolated frame is a collided unit region assigned with a plurality or a plurality of pairs of interpolated motion vectors,
calculates a rate of the collided unit regions occupying the unit regions present in a preset range with reference to the positions of the collided unit regions for each of the unit regions determined as the collided unit region,
calculates the correction weight coefficient for each of the collided unit regions by correcting the reference weight coefficient based on the rate, and
weight-averages the collided region of the forward motion-compensated image and the collided region of the backward motion-compensated image based on the calculated correction weight coefficient.

8. The frame interpolation device according to claim 2,
wherein the non-normal region is configured of the vacant region and the collided region, and
the interpolated frame generation unit determines whether each of the unit regions in the interpolated frame is a vacant unit region assigned with no interpolated motion vector, or a collided unit region assigned with a plurality or a plurality of pairs of interpolated motion vectors,
when the unit region is determined as the vacant unit region, calculates a rate of the vacant unit regions occupying the unit regions present in a preset range with reference to the positions of the vacant unit regions for each of the unit regions determined as the vacant unit region, and calculates the correction weight coefficient for each of the vacant unit regions by correcting the reference weight coefficient based on the rate,
when the unit region is determined as the collided unit region, calculates a rate of the collided unit regions occupying the unit regions present in a preset range with reference to the positions of the collided unit regions for each of the unit regions determined as the collided unit region, and calculates the correction weight coefficient for each of the collided unit regions by correcting the reference weight coefficient based on the rate, and
weight-averages corresponding regions of the forward motion-compensated image and the backward motion-compensated image based on the calculated correction weight coefficient.

9. The frame interpolation device according to claim 6,
wherein when the unit region is determined as the vacant unit region and the calculated rate is larger than a preset first threshold, the interpolated frame generation unit acquires the image of the region in the backward motion-compensated image as the image of the interpolated frame.

10. The frame interpolation device according to claim 6,
wherein when the unit region is determined as the vacant unit region and the calculated rate is smaller than a preset second threshold, the interpolated frame generation unit weight-averages the region of the forward motion-compensated image and the region of the backward motion-compensated image based on the reference weight coefficient.

11. The frame interpolation device according to claim 6,
wherein the interpolated frame generation unit acquires the image of the region in the backward motion-compensated image as the image of the interpolated frame when the unit region is determined as the vacant unit region and the calculated rate is larger than the preset first threshold, and weight-averages the region of the forward motion-compensated image and the region of the backward motion-compensated image based on the reference weight coefficient when the calculated rate is smaller than the preset second threshold.

12. The frame interpolation device according to claim 7,
wherein when the unit region is determined as the collided unit region and the calculated rate is larger than a preset third threshold, the interpolated frame generation unit acquires the image of the region in the forward motion-compensated image as the image of the region in the interpolated frame.

13. The frame interpolation device according to claim 7,
wherein when the unit region is determined as the collided unit region and the calculated rate is smaller than a preset fourth threshold, the interpolated frame generation unit weight-averages the region of the forward motion-compensated image and the region of the backward motion-compensated image based on the reference weight coefficient.

14. The frame interpolation device according to claim 7,
wherein the interpolated frame generation unit acquires the image of the region in the forward motion-compensated image as the image of the region in the interpolated frame when the unit region is determined as the collided unit region and the calculated rate is larger than the preset third threshold, and weight-averages the region of the forward motion-compensated image and the region of the backward motion-compensated image based on the reference weight coefficient when the calculated rate is smaller than the preset fourth threshold.

15. The frame interpolation device according to claim 8,
wherein the interpolated frame generation unit acquires the image of the region in the backward motion-compensated image as the image of the interpolated frame when the unit region is determined as the vacant unit region and the calculated rate is larger than the preset first threshold, and
acquires the image of the region in the forward motion-compensated image as the image of the region in the interpolated frame when the unit region is determined as the collided unit region and the calculated rate is larger than the preset third threshold.

16. The frame interpolation device according to claim 8,
wherein the interpolated frame generation unit weight-averages the region of the forward motion-compensated image and the region of the backward motion-compensated image based on the reference weight coefficient when the unit region is determined as the vacant unit region and the calculate rate is smaller than the preset second threshold, and
weight-averages the region of the forward motion-compensated image and the region of the backward motion-compensated image based on the reference weight coefficient when the unit region is determined as the vacant unit region and the calculated rate is smaller than the preset fourth threshold.

17. The frame interpolation device according to claim 8,
wherein the interpolated frame generation unit acquires the image of the region in the backward motion-compensated image as the image of the interpolated frame when the unit region is determined as the vacant unit region and the calculated rate is larger than the preset first threshold,
weight-averages the region of the forward motion-compensated image and the region of the backward motion-compensated image based on the reference weight coefficient when the unit region is determined as the vacant unit region and the calculated rate is smaller than the preset second threshold,
acquires the image of the region in the forward motion-compensated image as the image of the region in the interpolated frame when the unit region is determined as the collided unit region and the calculated rate is larger than the preset third threshold, and
weight-averages the region of the forward motion-compensated image and the region of the backward motion-compensated image based on the reference weight coefficient when the unit region is determined as the vacant unit region and the calculated rate is smaller than the preset fourth threshold.

18. The frame interpolation device according to claim 1,
wherein the unit region is made of one pixel.

19. A frame interpolation method comprising:
a motion vector interpolation step of calculating interpolated motion vectors indicating motions of an image between two frames and an interpolated frame based on motion vectors indicating motions of an image between the two frames and a temporal position of the interpolated frame inserted between the two frames, and assigning the calculated interpolated motion vectors to the interpolated frame per unit region;
a motion-compensated image generation step of generating a forward motion-compensated image generated based on image information on the forward frame out of the two frames and the interpolated motion vectors, and a backward motion-compensated image generated based on image information on the backward frame out of the two frames and the interpolated motion vectors; and
an interpolated frame generation step of generating the interpolated frame by averaging corresponding regions of the forward motion-compensated image and the backward motion-compensated image by different weights between a normal region in which one or one pair of interpolated motion vectors is assigned per unit region and a non-normal region which is configured of at least one of a collided region assigned with a plurality or a plurality of pairs of interpolated motion vectors per unit region and a vacant region assigned with no interpolated motion vector.

20. A computer readable recording medium recording a program therein, the program for causing a computer to function as:
a motion vector interpolation unit that, based on motion vectors indicating motions of an image between two frames and a temporal position of an interpolated frame inserted between the two frames, calculates interpolated motion vectors indicating motions of an images between the interpolated frame and the two frames, and assigns the calculated interpolated motion vectors to the interpolated frame per unit region;
a motion-compensated image generation unit that generates a forward motion-compensated image generated based on image information on the forward frame out of the two frames and the interpolated motion vectors, and a backward motion-compensated image generated based on image information on the backward frame out of the two frames and the interpolated motion vectors; and
an interpolated frame generation unit that generates the interpolated frame by averaging corresponding regions of the forward motion-compensated image and the backward motion-compensated image by different weights between a normal region in which one or one pair of interpolated motion vectors is assigned per unit region and a non-normal region which is configured of at least one of a collided region assigned with a plurality or a plurality of pairs of interpolated motion vectors per unit region and a vacant region having assigned with no interpolated motion vector.
